(19) United States
(12) Patent Application Publication
(10) Pub. No.: US 2019/0217431 A1
(43) Pub. Date: Jul. 18, 2019

(54) MULTIFUNCTIONAL MACHINING CENTER

(71) Applicant: CSM MASCHINEN GMBH, Landsberg am Lech (DE)

(72) Inventor: Helmut SCHUSTER, Landsberg am Lech (DE)

(73) Assignee: CSM MASCHINEN GMBH, Landsberg am Lech (DE)

(21) Appl. No.: 16/326,303

(22) PCT Filed: Jun. 8, 2017
(86) PCT No.: PCT/EP2017/064042

§ 371 Date: Feb. 18, 2019

(30) Foreign Application Priority Data
Jun. 19, 2016 (DE) 10 2016 007 407.8

(51) Int. Cl. B23Q 1/01

(52) U.S. Cl. CPC B23Q 1/015; B23Q 37/007; B23Q 1/017

(57) ABSTRACT

Machine tool and a base for a machine tool comprising a machine bed to support a first work module having a first end effector held thereon, and a second work module having a second end effector held thereon on a base surface in an area between two mutually opposed sides which delimit the machine bed, the sides extending between an underside of the machine bed and an upper side of the machine bed, when viewed in the vertical direction; a first bearing element which is fixed relative to the machine bed for holding the first work module; and a second bearing element which is fixed relative to the machine bed for holding the second work module; wherein the first bearing element and the second bearing element are arranged one above the other, when viewed in the vertical direction.

### REFERENCE TO RELATED APPLICATIONS

This application is a U.S. national stage application of International Patent Application No. PCT/EP2017/064042, filed Jun. 8, 2017, and claims the benefit of priority of German Application No. 10 2016 007 407.8, filed Jun. 19, 2016, the entire disclosures of which are incorporated herein by reference.

### FIELD OF THE INVENTION

The present invention relates to a base for a machine tool, a work module for a machine tool and a machine tool with the base and the work module.

### BACKGROUND OF THE INVENTION

A machine tool in the form of a lathe with a base is known from DE 20 2015 102 057 U1. The base comprises a machine bed on which a first work module with a chuck as end effector held thereon and a second work module in the form of a turret held thereon. The first work module is guided on the machine bed on a guide rail in the form of a slide guidance. The slide guidance and the mount of the turret are on the same level. While the lathe is in operation, a turning tool is set up from the turret and held radially in an axial motion path of the chuck. An unmachined part clamped in the chuck is turned and guided radially into the turning tool over the slide guidance. In this way, the unmachined part is machined in a rotating movement. The machine tool of DE 20 2015 102 057 U1, however, cannot be converted easily into another machine tool such as a milling machine.

A machine tool with a base is known from DE 20 2009 014 709 A1. The base comprises a machine bed holding a first work module with a chuck as end effector held thereon and several second work modules to machine an unmachined part clamped in the chuck. The first work module is executed on a guide rail in the form of a carriage guidance. The first work module guides the unmachined part clamped in the chuck outside of the machine bed on the outer wall of the machine bed between the individual second work modules. In this way, the unmachined part is transported between the individual second work modules and can be machined there. The individual second work modules are replaceable.

As the individual work modules are guided outside on the outer wall of the machine bed, the longitudinal side of the machine bed is used to hold as many second work modules as possible. Even though this leads to a high modular design of the machine tool itself, if several machine tools are placed one next to the other, a lot of space is required here, because the individual machine tools must be set up with their front side next to each other. In addition, the range of motion of the chuck of this machine tool is basically limited to two directions of movement, i.e. vertically and longitudinally. A movement in transverse direction does not really make sense in the machine tool of DE 20 2009 014 709 A1.

It is the object of the invention to present an improved base for a machine tool which provides a space-saving, highly modular and at the same time cost-saving design of a machine tool.

According to one aspect of the invention, a base for a machine tool comprises a machine bed to support a first work module with a first end effector held thereon and a second work module with a second end effector held thereon on a base surface in an area between two mutually opposed sides which delimit the machine bed, the sides extending between an underside of the machine bed and an upper side of the machine bed, a first bearing element, which is fixed relative to the machine bed for holding the first work module, and a second bearing element which is fixed relative to the machine bed for holding the second work module, wherein the first bearing element and the second bearing element are arranged one above the other when viewed in the vertical direction.

Starting from DE 20 2009 014 709 A1, the presented base is based on the consideration of not guiding the work modules along the outer wall of the machine bed but along the inner wall of the machine bed. In this way, the walls of the thus resulting machine tool remain free, and a plurality of machine tools can be arranged side-by-side in a space-saving manner. The presented idea of a modular design can nonetheless be realised fully. The improved centre of gravity means that the machine bed itself can be lighter in weight, for example in a sheet metal construction.

### SUMMARY OF THE INVENTION

One embodiment comprises the presented base having a basic part being placed on the sides on the upper side of the machine bed, which separates the first bearing element from the second bearing element. In this way, the inside of the machine bed can be closed at the sides, and can easily be accessed, for example for replacing work modules, by removing the basic part.

In a particular embodiment of the presented base, the basic part is a plate. Plates can be produced and transported easily, at reasonable prices and in a standardised manner.

In a preferred embodiment of the presented base, the first bearing element is arranged on an upper side of the basic part, pointing away from the upper side of the machine bed when viewed in the vertical direction. In this way, the outside area above the base can also be used to bear the work module without deviating from the inventive idea, according to which the sides of the final machine tool can remain unblocked for a space-saving design of a production line.

In an additional embodiment of the presented base, the first bearing element is a guide rail to guide the first work module in a guide direction at an angle to the vertical direction, wherein another guide rail extending parallel and at a distance to the guide rail is arranged on the upper side of the basic part. These two guide rails enable a very stable bearing for the first work module.

In a further embodiment, the presented base comprises a further bearing element between the two guide rails to bear a conveying element. In this way, a proper design of the first work module makes it possible to integrate a third work module into the final machine tool to transport an unmachined part or workpiece and/or tool not only via an end face of the machine tool but via both end faces of the machine tool.

In another embodiment of the presented machine tool, the second bearing element is arranged below the basic part when viewed in the vertical direction.

In accordance with a further aspect of the invention, a work module for a machine tool comprises a base unit, two installation legs which are arranged at a distance from one another and extending against a vertical direction from the base unit for installing on a bearing unit, and a holding element to hold an end effector. This work module presents a potential design which allows for the use of the above-mentioned conveyor belt.

In accordance with a further aspect of the invention, a machine tool comprises one of the described bases and the previously described work module as the first work module, which can slide on the first bearing element with one of its installation legs. The second installation leg may then be supported on the second parallel-running guide rail.

In one embodiment the mentioned machine tool comprises the conveying element between the two installation legs to convey a tool or an unmachined part or workpiece.

The above-described properties, features and advantages of this invention, as well as the manner in which they are achieved, will become clearer in connection with the following description of the embodiments, which are described in more detail in connection with the drawings, in which:

### BRIEF DESCRIPTION OF THE FIGURES

FIG. 1 is a schematic representation of a production line.

FIG. 2 is a perspective view of a part of the production line of FIG. 1.

FIG. 3 is a perspective view of a machine tool executed as a flange lathe machine for the production line of FIG. 1.

FIG. 4 is a perspective view of a machine tool executed as an alternative flange lathe machine for the production line of FIG. 1.

FIG. 5 is a perspective view of a machine tool executed as a shaft turning machine for the production line of FIG. 1.

FIG. 6 is a perspective view of a machine tool executed as a bar turning machine for the production line of FIG. 1.

FIG. 7 is a perspective view of a machine tool executed as an alternative bar turning machine for the production line of FIG. 1.

FIG. 8 is a perspective view of a machine tool executed as a milling machine for the production line of FIG. 1.

FIG. 9 is a perspective view of a machine tool executed as a shaft milling machine for the production line of FIG. 1.

FIG. 10 is a perspective view of a machine tool executed as a shaft finishing machine for the production line of FIG. 1.

FIG. 11 is a perspective view of a machine tool executed as a double-table milling machine for the production line of FIG. 1.

In the drawings, the same technical elements are provided with the same reference signs, and are only described once. The drawings are purely schematic, and, in particular, do not reflect the actual geometric proportions.

### DETAILED DESCRIPTION OF PREFERRED EMBODIMENTS

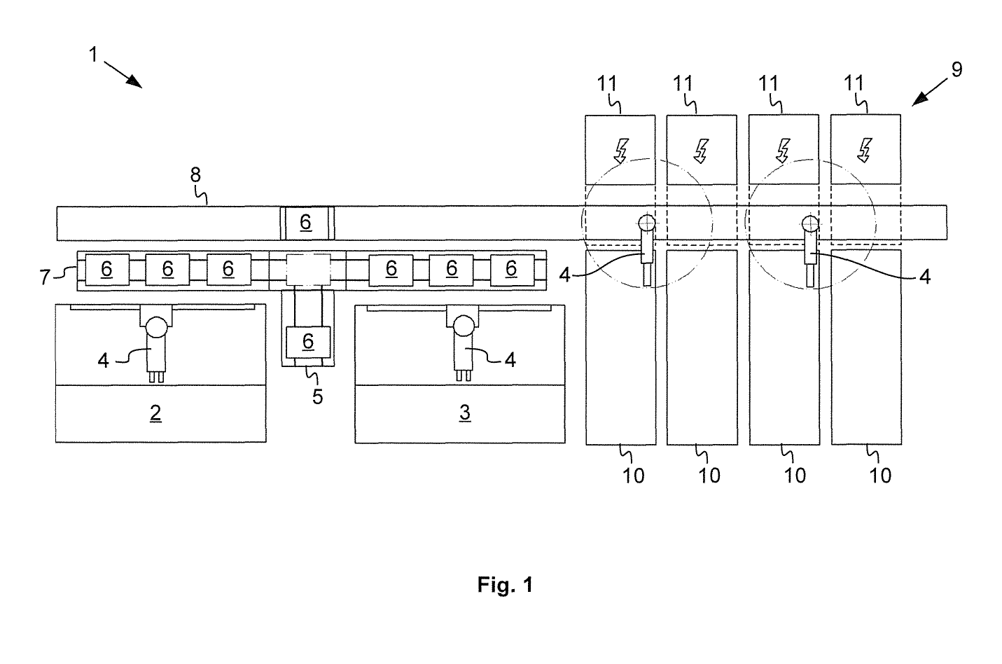

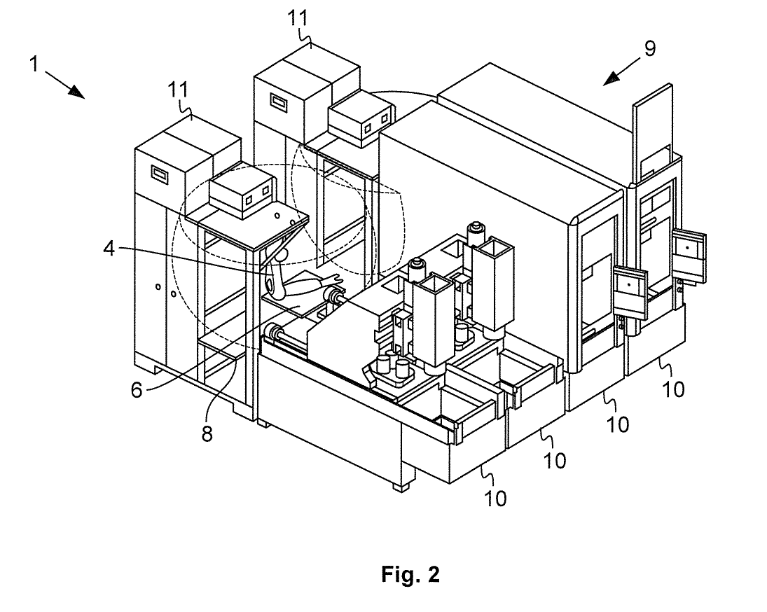

Reference is made to FIGS. 1 and 2 showing a schematic representation of a production line 1. The production line 1 shall be used to manufacture not further specified finished products from unmachined part by means of tools.

The production line 1 comprises a compartment for unmachined parts 2, in which the unmachined parts are stored, and a tool compartment 3, in which the tools are stored. Each gripper robot 4 in the compartment for unmachined parts 2 and in the tool compartment 4 can grip one unmachined part or a tool and use it to assemble a plate 6 on a setup station 5. A sufficient number of plates 6 is provided in a plate store 7.

The plates 6 equipped with the unmachined parts or the tools can then be transported over a conveyor belt 8 to a row 9 with machine tools 10. The machine tools 10 jointly perform a manufacturing process to fulfil the previously mentioned objective to use the tools for producing not further specified workpieces from the unmachined parts.

Every machine tool 10 in the row 9 carries out one or several intermediate steps of the manufacturing process. For this purpose, gripping robots 4 grip the unmachined parts and/or the tools from the plates 6, and equip the machine tool 10 with them to carry out the respective intermediate step. After the completion of the intermediate step, or as soon as a tool is no longer required, the gripper robots 4 put either the intermediate or finished product, or the tool which is no longer used, back on the respective plate 6, which then either moves to the next machine tool 10 and thus to the next intermediate step or back to the compartments 2, 3. In order to differentiate clearly in the following between the terms unmachined part and workpiece, an unmachined part is taken to be the material to be machined which is conveyed to a machine tool 10 regardless of whether it is an unmachined part from the compartment for unmachined parts 2 or an intermediate product from a previous intermediate step in another machine tool. A workpiece is taken to be an unmachined part machined by a machine tool 10. A workpiece leaving a machine tool 10 may therefore be the unmachined part for another machine tool 10.

The energy supply and control of the components of the production line 1 is carried out via the corresponding control cabinets 11. A control centre not shown in any further detail may coordinate the material flow by means of the gripper robots 4 and the plates 6.

The production line 1 is highly modular. This means that the production line 1 can be adapted to as many manufacturing scenarios as possible by simply replacing modules, so that, apart from possible program adjustments, no further mechanical conversion measures are necessary to adapt the production scenarios.

One the one hand, this is due to the arrangement of the individual machine tools 10 side-by-side. Usually it is not necessary to adapt the entire manufacturing process for a new manufacturing scenario, but only individual intermediate steps have to be adapted to the new manufacturing scenario. The production line shown in FIG. 1 makes it possible to re-configure these intermediate steps to be adapted individually by replacing the individual machine tools 10. This is why every intermediate step in the manufacturing process in the production line 1 should be realised by an individual machine tool 10.

On the other hand, the individual machine tools 10 themselves also have a modular design. In this way, the machine tools 10 can be adapted individually to new intermediate steps by simple reconfiguration. This shall be explained in the following using some examples.

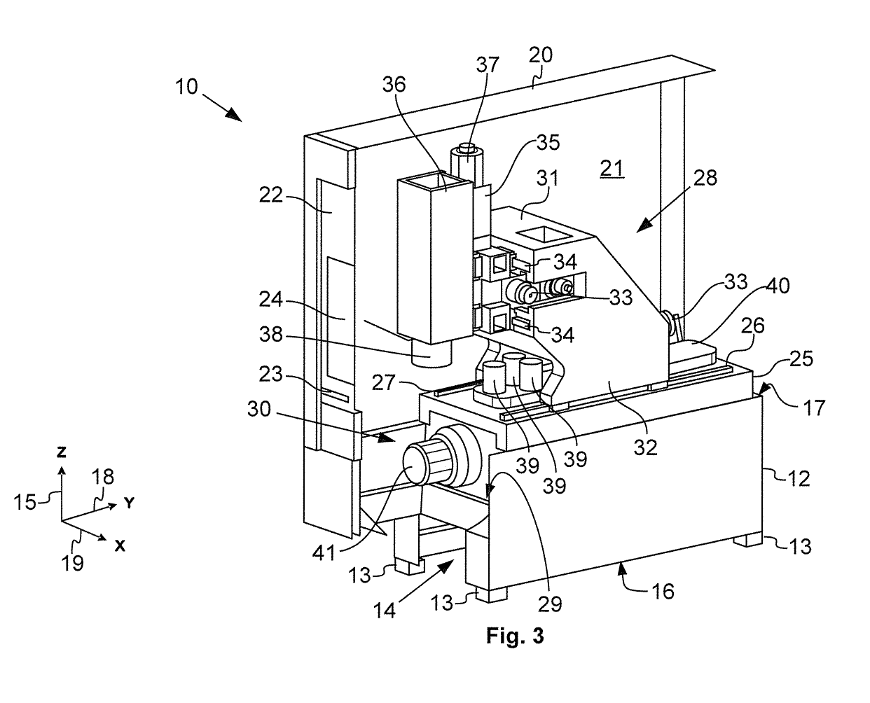

Reference is made to FIG. 3, which is a perspective view of a machine tool 10 executed as a flange lathe machine for the production line of FIG. 1.

Before the flange lathe machine is explained in further detail as an example of the machine tool 10, the general design of every machine tool 10 which ensures the modularity shall first be explained.

Every machine tool 10 has a machine bed 12 which is carried on feet 13. As an example, the machine bed 12 is executed as a sheet metal construction. An interior space 14 is created inside the machine bed 12 in which work modules can be inserted. This will be described in more detail later.

When viewed in a vertical direction 15, the machine bed 12 extends between an underside 16 and an upper side 17, wherein the feet 13 are attached to the underside 16. The machine bed 12 also extends in a longitudinal direction 18 with a greater length than in a transverse direction 19. In the figures, the vertical direction 15 is also indicated as z-direction, the longitudinal direction 18 also as y-direction and the transverse direction 19 also as x-direction.

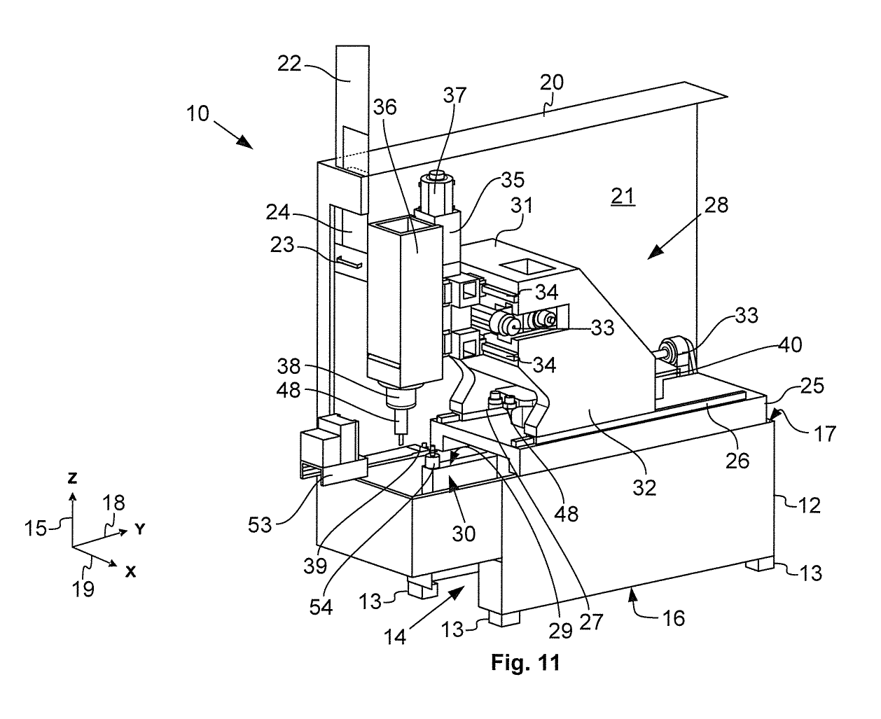

A protective housing 20 is placed on the machine bed 12. The protective housing 20 may, for example, protect persons standing in the area of the machine tool 10 from spinning materials. An inside space 21 of the protective housing 20 can be accessed from outside via a lift door 22, which is shown in FIG. 3 in closed condition. To open the lift door 22, a handle 23 attached to the lift door is drawn in the vertical direction. An example of the open lift door 22 is shown in FIG. 11. The inside space 21 of the protective housing 20 is visible from the outside through a window 24 in the lift door 22.

In the inside space 21 of the protective housing 20, a plate-shaped basic part is fixed on the upper side 17 of the machine bed 12, which is referred to in the following as the basic plate 25. The basic part shown as a plate is only an example and can be executed in any possible form. On the basic part executed as a basic plate 25, a first bearing element in the form of a first guide rail 26 and a second guide rail 27 are arranged running parallel and in the longitudinal direction 18 as guide direction.

Because the basic plate 25 is held on the machine bed 12 in a fixed manner, the guide rails 26, 27 are also arranged in a fixed manner relative to the machine bed 12. The machine bed 12 and the basic plate 25 jointly comprise a base to hold several work modules. In this case, the basic plate 25 defines the maximum base surface in which the work modules should be held. These work modules hold and move the so-called end effectors. The term end effector actually refers to the end of a kinematic chain in the robotics. Deviating slightly from this definition, the end effectors are taken here as the points in a machine tool which grip the unmachined part for machining. This means that an end effector is either a tool or a holder for the unmachined part, such as a chuck.

A first work module 28 can be supported on the guide rails 26, 27 to be moved in the longitudinal direction 18 in a manner still to be explained. Below the basic plate 25, a second bearing element is arranged on the machine bed 12 in the shape of a support bearing 29, also called a support. A second work module 30 can be supported on the support bearing 29.

The first work module 28 comprises a base unit 31. Installation legs 32 protrude from the base unit 31 against the vertical direction 18 on the side pointing to the upper side 17 of the machine bed 12. The base unit 31 and the installation legs 32 jointly form a carriage, wherein the installation legs 32 are inserted in the first guide rail 26 and the second guide rail 27 for guiding. A belt-driven spindle 33 is arranged on the side of the machine tool 10 opposite the lift door 22 which can move the carriage 31, 32 on the guide rails 26, 27 in the longitudinal direction 18. Because the carriage 31, 32 can be moved in the longitudinal direction 18, it shall be referred to in the following as Y-carriage 31, 32.

Two further guide rails 34 are arranged on a side of the base unit 31 of the work module 28 pointing to the lift door 22, which guide another carriage 35 in the transverse direction 19. Because the further carriage 35 can be moved in the transverse direction 19, it shall be referred to in the following as X-carriage 35. The X-carriage 35 can also be driven via a belt-driven spindle 33.

Finally, a pivoting headstock 36 is arranged on the X-carriage 35 and thus on the first work module 28, which can be moved in the vertical direction 15 via a spindle direct drive 37. Therefore, the pivoting headstock 36 is referred to in the following as Z-carriage 36.

An end effector in the form of a rotatable chuck 38 is arranged on the lower end of the Z-carriage 36 when viewed against the vertical direction 15, in which unmachined parts 39 can be clamped and turned. The unmachined parts 39 are on a conveyor belt 40, which is supported on another non-visible bearing element, and guided underneath the base unit 31 of the Y-carriage 31, 32. Finally, a turret 41 is supported on the support bearing 29, from which a turning tool not shown in any further detail can be drawn out upwards in the vertical direction 15 to machine the unmachined parts 39.

The chuck 38 can be moved by means of the X-carriage 35, the Y-carriage 31, 32 and the Z-carriage 36 in all three directions in space 15, 18, 19.

For flange turning, the chuck 38 is used to grip and turn an unmachined part 39 which is fed into the machine tool 10 via the conveyor belt 40. As the chuck 38 can move in all three directions in space 15, 18, 19, the turning unmachined part clamped in the chuck 38 can be conveyed via a tool into the turret 41 and moved there in accordance with a contour to be manufactured. After completing the flange turning work, the thus manufactured workpiece is put back on the conveyor belt 40, which then transports the finished workpiece out of the machine tool 10.

As can be seen in FIG. 3, only three carriages and the corresponding three drives are required for flange turning including gripping the workpiece 39 from the conveyor belt 40. Unlike DE 20 2015 102 057 U1, the machine tool 10 of FIG. 3 does not require its own workpiece import and export mechanisms. The X, Y and Z carriages, which are also used to move at least one end effector, can be used to grip the unmachined part 39 and to put down the workpiece with the chuck 38 respectively. This is not only significantly cost-saving, it also requires significantly less construction space. However, the machine tool of FIG. 3 can be integrated fully into the production line 1 of FIG. 1 without losing freedom of movement as in DE 20 2009 014 709 U1 in the transverse direction 19.

The advantages are achieved in particular by the vertical arrangement of the first work module 28 and the second work module 30 one above the other and approaching the unmachined parts 39 between the two work modules 28, 30. Although the two work modules 28, 30 may basically be arranged in any way one above the other, the basic plate 25, on which the first work module 28 can be moved, provides a stabilisation of the machine bed 12.

In general, plates are easy and cheap to procure. This is why the design of the invention with a plate as shown in FIG. 3 is particularly favourable.

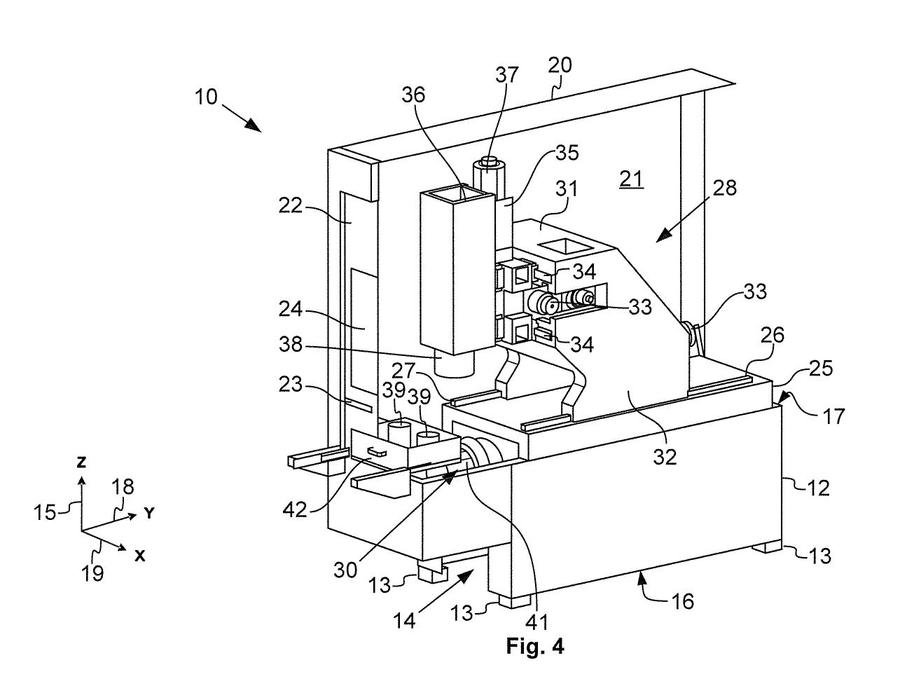

Reference is made to FIG. 4, which is a perspective view of a machine tool 10 executed as an alternative flange lathe machine for the production line of FIG. 1.

A comparison of the machine tools 10 of FIG. 3 and FIG. 4 gives a particularly clear picture of the modularity achieved. By simply installing a drawer 42 underneath the lift door 22, it is very easy to provide the machine tool 10 with a manual loading option for unmachined parts 39 by means of the drawer 42 as an alternative or additional option to the automated provision of the unmachined parts 39 via the conveyor belt 40 of FIG. 3. Obviously, the drawer 42 can also be loaded automatically with unmachined parts 39 if this is desired.

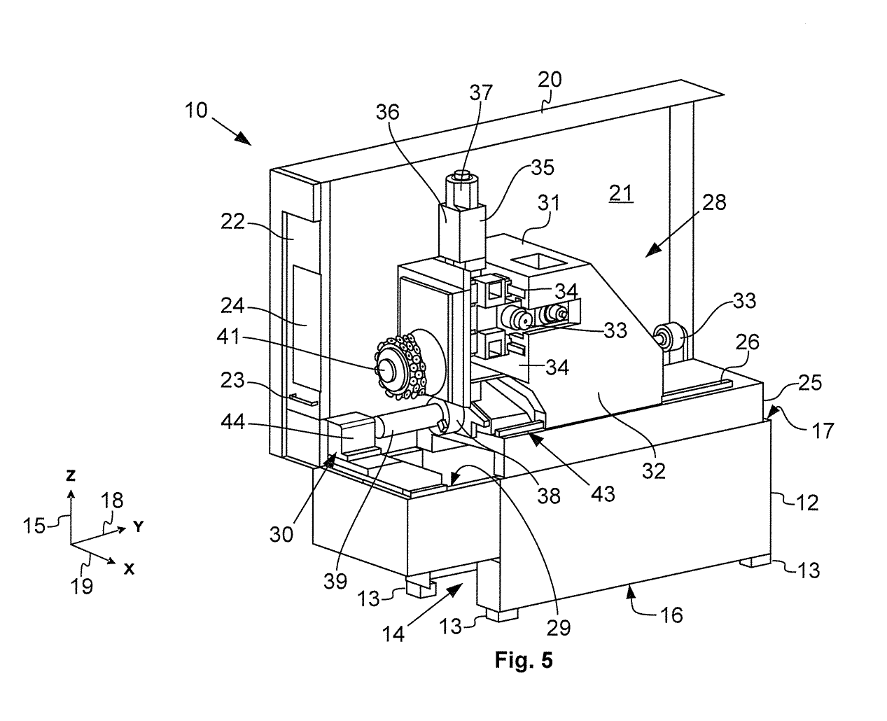

Reference is made to FIG. 5, which shows a perspective view of a machine tool 10 executed as a shaft turning machine for the production line of FIG. 1.

The fundamental difference between the machine tool 10 of FIG. 5, which is executed as a shaft turning machine, and the machine tools 10 of FIGS. 3 and 4, which are executed as flange lathe machines, is that the turret 41 is now fixed to the first work module 28. Otherwise, the first work module 28 basically has the same design as the machine tools of FIGS. 3 and 4.

The unmachined part 39 to be machined is clamped in a vice 43 with the chuck 38, which is attached to a spindle without reference sign, which can be moved in the longitudinal direction 18. The chuck 38 of the vice 43 stands on the basic plate 25. A tailstock 44 belonging to the vice 43 lying opposite the chuck 38 in longitudinal direction rests on the support bearing 29. In the present embodiment, the support bearing is located on the upper side 17 of the machine bed 12. To increase the stability, the tailstock 44 can be bolted to the machine bed 12.

The machine tool 10 of FIG. 5 can be loaded with unmachined parts 39 from the front and from the back. In FIG. 5, the machine tool 10 is loaded with unmachined parts 39 from the front.

It can clearly be seen in FIG. 5 that the modification of the machine tool 10 from a flange lathe machine according to FIG. 3 or 4 to a shaft turning machine according to FIG. 5 only required the attachment of the turret 41 to the first work module 28. As second work module 30, the tailstock 44 is to be installed in the shaft turning machine 10.

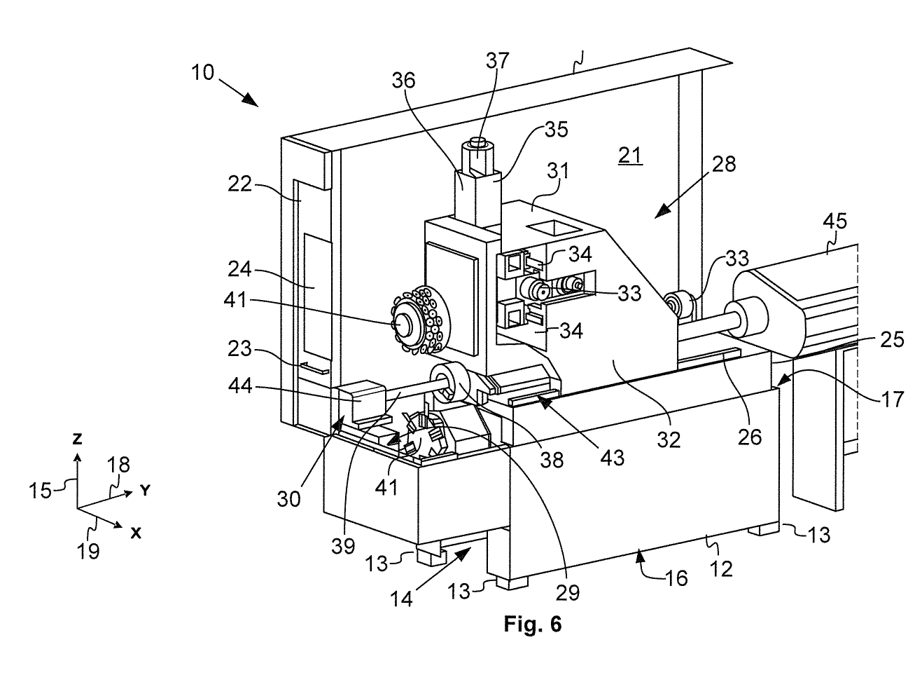

Reference is made to FIG. 6, which is a perspective view of a machine tool 10 executed as a bar turning machine for the production line of FIG. 1.

The machine tool 10 executed as a bar turning machine is an example of how the machine tool 10 of FIG. 5 executed as a shaft turning machine can also be loaded with unmachined parts 39 from the back in longitudinal direction 18. For this purpose, a magazine 45, set up behind the machine tool 10 when viewed accordingly in longitudinal direction 18, loads the machine tool 10 with the shaft or the rod as unmachined part 39, and unloads the finished workpiece from the machine tool 10 accordingly after machining.

FIG. 6 also shows an optional turret 41, which could be arranged underneath the unmachined part 39 when viewed in the vertical direction 15. For the sake of brevity, this optional turret 41 shall not be described in any further detail.

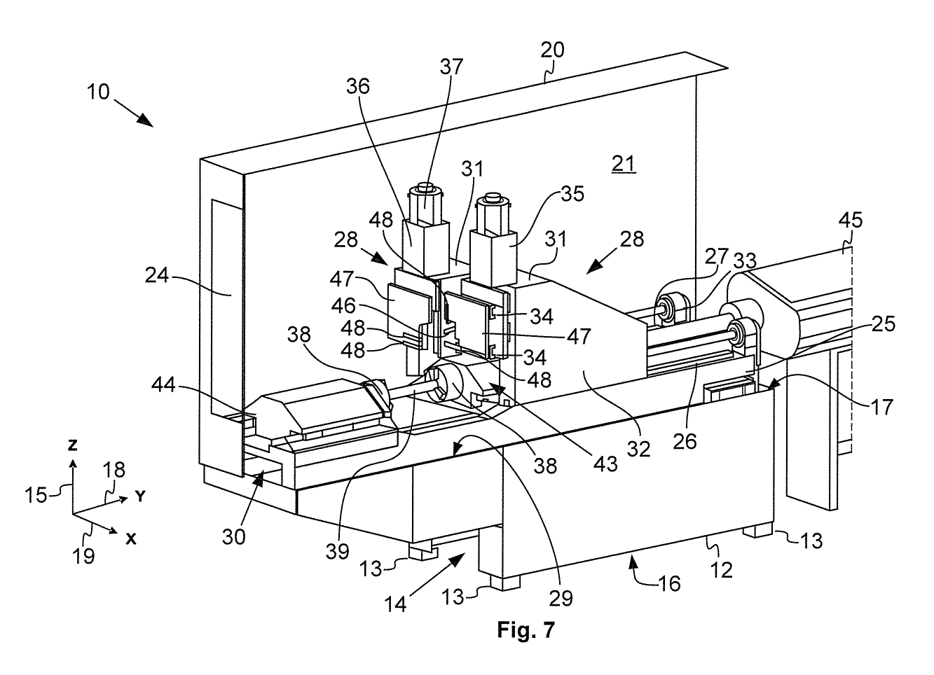

Reference is made to FIG. 7, which is a perspective view of a machine tool 10 executed as an alternative bar turning machine for the production line of FIG. 1. FIG. 7 shows several technical elements which, for reasons of clarity, have no reference signs.

As indicated in FIG. 6, further tools can be integrated in the machine tool 10 using an optional additional turret 41. In FIG. 7, the idea of integrating more tools is extended further by executing the first work module 28 twice. The unmaschined part 39, in this case a rod, is machined between the two first work modules 28, which are guided relative to each other via a supporting guide rail 46.

Instead of the turret 41 of FIGS. 3 to 6, a block die is used in FIG. 7. It is a tool-carrying plate 47 to which tools 48 are attached respectively. The tools 48 on the tool-carrying plate 47 can be transported specifically to the workpiece 39 with the first work module 28 via the corresponding X, Y and Z-carriages for machining.

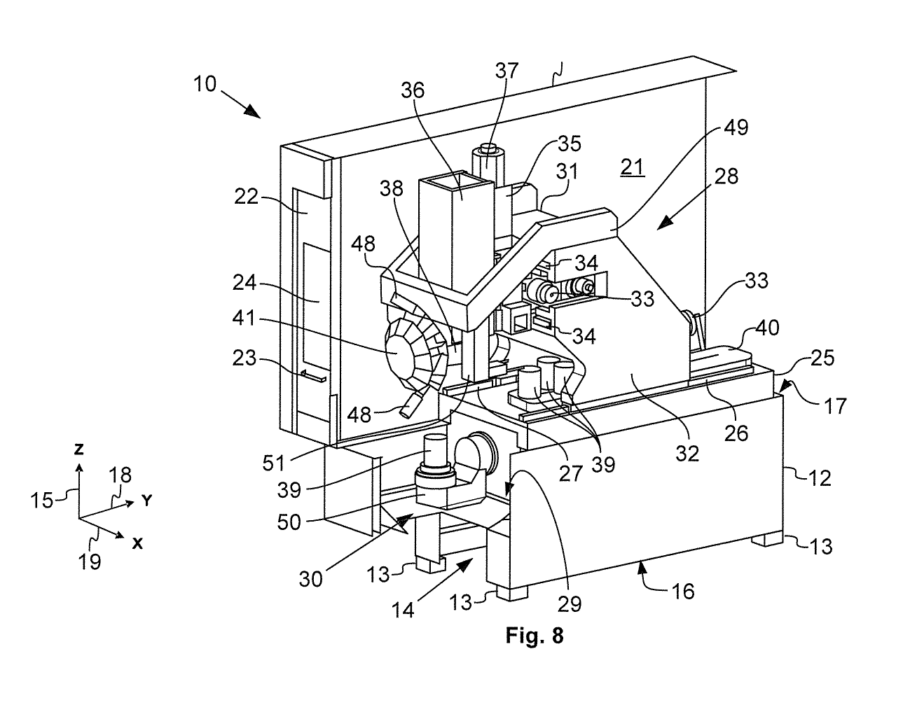

Reference is made to FIG. 8, which is a perspective view of a machine tool 10 executed as a milling machine for the production line of FIG. 1.

Analogous to the machine tool 10 of FIG. 4, the machine tool 10 of FIG. 8 shows a chuck 38 on the first work module 28, which, however, does not turn. In this chuck 38 tools 48 are clamped which are provided by a turret 41 which is attached to the first work module 28 by means of a bracket 49. The chuck 38 and the clamped tool 48 therefore jointly form an end effector. The turret 41 in FIG. 8 can be swivelled around the transverse axis 19. In this way, the tools 48 held in the turret 41 are turned into the chuck 38 to be inserted there, and can be removed again accordingly.

The unmachined part 39 to be machined is held in a turn/swivel bridge 50 as second work module 30, which rests on a support bearing 29 analogous to FIG. 3. The unmachined parts 39 can be provided analogous to FIG. 3 via the conveyor belt 40. The machine tool 10 can also be loaded, however, via the drawer 24 from FIG. 4 as an alternative or additional option. As the turn/swivel bridge 50, unlike in FIGS. 3 and 4, cannot transport the chuck 38 with the clamped unmachined part 39 to the workpieces 39 on the conveyor belt 40, a gripper 51 is arranged to grip unmachined parts 39 on the conveyor belt 40 and load the turn/swivel bridge 50 with the gripped unmachined part 39. Accordingly, after the completion of the workpiece, the gripper 51 can unload the finished workpiece from the turn/swivel bridge 50.

FIG. 8 shows particularly clearly how easy it is, due to the arrangement of the first work module 28 and the second work module 30 placed on top of each other when viewed in the vertical direction 15, to convert a machine tool 10 executed as a lathe, for example from FIG. 3, into a milling machine. A fundamental new dimensioning as would be required for the machine tool of DE 20 2015 102 057 U1 is not necessary.

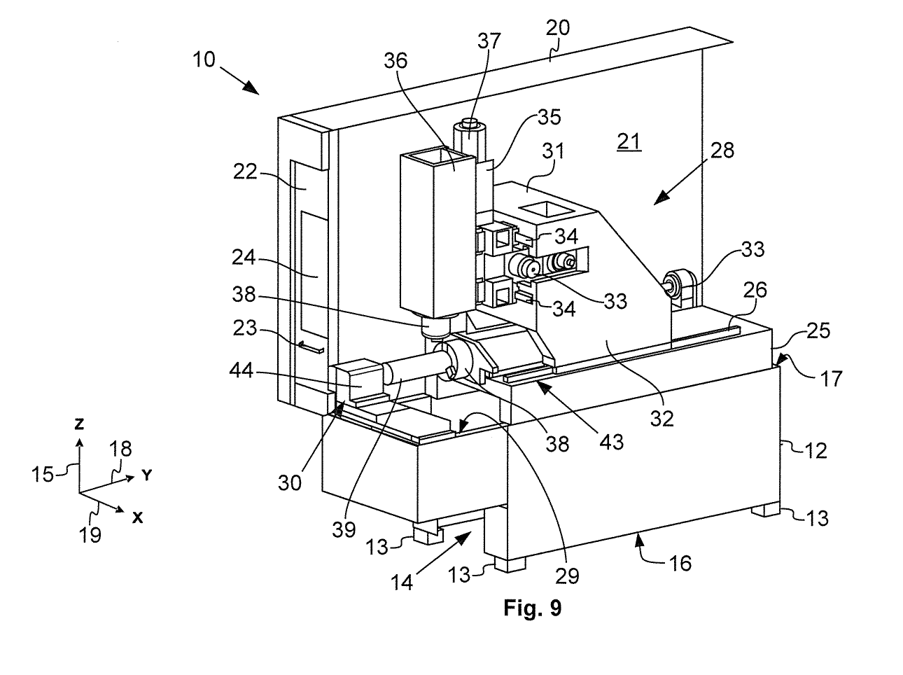

The modular principle becomes even clearer in the comparison of FIG. 9, showing a perspective view of a machine tool 10 executed as a shaft milling machine for the production line 1 of FIG. 1, and the machine tool of FIGS. 4 and 5 executed as a shaft milling machine. Here, instead of the stationary turret 41 in FIG. 5, only the rotating chuck 38 on the first work module 28 has been changed, while the unmachined part 39, i.e. the shaft or rod itself, is stationary. Also in FIG. 9, the tool to be clamped in the chuck 38 on the first work module 28 can be provided, for example, via the turret 41 of FIG. 8, which is attached to the first work module 28 by means of the bracket 51.

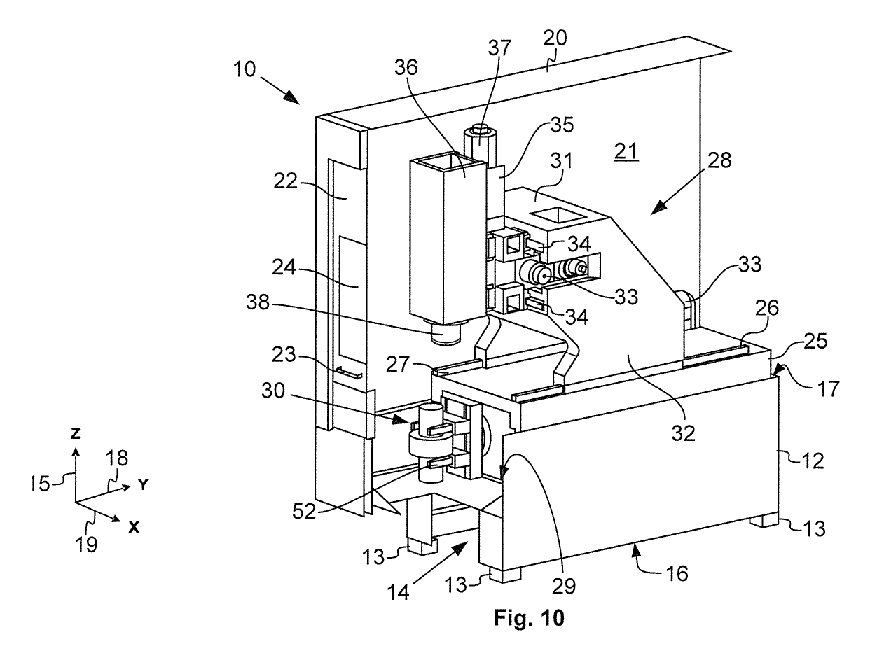

In FIG. 10, showing a perspective view of a machine tool 10 executed as a shaft finishing machine for the production line 1 of FIG. 1, the second work module 30 is executed as a rotatable gripper 52 instead of as a turn/swivel bridge 50 as in FIG. 8.

Otherwise, all characteristics of FIG. 8 can also be applied for the machine tool 10 of FIG. 10.

Reference is made to FIG. 11, which is a perspective view of a machine tool 10 executed as a double table milling machine for the production line of FIG. 1.

The machine tool 10 of FIG. 11 shows clearly that the tool 48 and the unmachined part 39 to be machined must not necessarily be provided via the same side of the machine tool 10. As shown in FIG. 11, the tools 48 can be led into the machine tool 10 from the back when viewed in the longitudinal direction 18 via a conveyor belt 40, while the unmachined parts 39 to be machined can be led into the machine tool 10 from the front when viewed in the longitudinal direction 18 via a loading system 53.

In the machine tool 10 of FIG. 11, the unmachined parts 39 to be machined can be put in place by the loading system 53 on an end effector in the form of a tool table 54, which is supported on a support bearing 29 in the machine bed 12.

The production line 1 of FIG. 1 is only an example. The modular design of the machine tools 10 provide a plurality of design possibilities for the production line 1.

For example, tools 48 and unmachined parts 39 must not necessarily be provided from one side of the machine tools 10, which is shown particularly clearly in FIG. 11. Neither the inflow or outflow of the tools 48 and unmachined parts 39 and the workpieces have to be carried out via the same side of the machine tool 10 as in production line 1 of FIG. 1.

The modular design of the machine tools 10 with the associated minimum material and construction space requirements for manufacturing can be realised in any manner.

1. Base for a machine tool comprising:
a machine bed to support a first work module having a first end effector held thereon, and a second work module having a second end effector held thereon on a base surface in an area between two mutually opposed sides which delimit the machine bed, the sides extending between an underside of the machine bed and an upper side of the machine bed, when viewed in the vertical direction;
a first bearing element which is fixed relative to the machine bed for holding the first work module; and
a second bearing element which is fixed relative to the machine bed for holding the second work module;
the first bearing element and the second bearing element are arranged one above the other, when viewed in the vertical direction.

2. Base as claimed in claim 1, comprising a basic part which detachably rests on an upper side of the machine bed, which separates the first bearing element from the second bearing element and seals an interior space in the machine bed, in which the second bearing element is arranged.

3. Base as claimed in claim 2, wherein the basic part is a plate.

4. Base as claimed in claim 3, wherein the first bearing element is arranged on an upper side of the basic part, pointing away from the upper side of the machine bed when viewed in the vertical direction.

5. Base as claimed in claim 4, wherein the first bearing element is a guide rail to guide the first work module in a guide direction at an angle to the vertical direction, wherein another guide rail running parallel and at a distance to the guide rail is arranged on the upper side of the basic part.

6. Base as claimed in claim 5, comprising a further bearing element between the two guide rails to bear a conveying element.

7. Base as claimed in claim 6, wherein the second bearing element is arranged underneath the basic part when viewed in vertical direction.

8. Work module for a machine tool comprising a base unit, two installation legs which are arranged at a distance from one another and extend against a vertical direction from the base unit for installation on a bearing unit, and a holding element to hold an end effector.

9. Machine tool, comprising a base as claimed in claim 6 in combination with a work module as claimed in claim 8, which is supported on the first bearing element with one of its installation legs.

10. Machine tool as claimed in claim 9, comprising a conveying element arranged between the two installation legs for conveying a tool or an unmachined part.
